(19) United States
(12) Patent Application Publication
(10) Pub. No.: US 2012/0094210 A1
(43) Pub. Date: Apr. 19, 2012

(54) INK COMPRISING POLYMER PARTICLES, ELECTRODE, AND MEA

(75) Inventors: Oemer Uensal, Mainz (DE); Sigmar Braeuninger, Hemsbach (DE)

(73) Assignee: BASF SE, LUDWIGSHAFEN (DE)

(21) Appl. No.: 13/380,194

(22) PCT Filed: Jul. 6, 2010
(86) PCT No.: PCT/EP10/59597

§ 371 Date: Dec. 22, 2011

(30) Foreign Application Priority Data
Jul. 7, 2009 (EP) 09164798.2

(51) Int. Cl. H01M 8/10; B01J 37/30; H01M 4/90

(52) U.S. Cl. 429/483; 502/11; 429/535

(57) ABSTRACT

Catalyst ink comprising one or more catalyst materials, a liquid medium and polymer particles comprising one or more proton-conducting polymers, an electrode comprising at least one catalyst ink according to the present invention, a membrane-electrode assembly comprising at least one electrode according to the invention or comprising at least one catalyst ink according to the present invention, a fuel cell comprising at least one membrane-electrode assembly according to the invention and also a process for producing a membrane-electrode assembly according to the present invention.

The present invention relates to a catalyst ink comprising one or more catalyst materials, a liquid medium and polymer particles comprising one or more proton-conducting polymers, an electrode comprising at least one catalyst ink according to the present invention, a membrane-electrode assembly comprising at least one electrode according to the invention or comprising at least one catalyst ink according to the present invention, a fuel cell comprising at least one membrane-electrode assembly according to the invention and also a process for producing a membrane-electrode assembly according to the present invention.

Polymer electrolyte membrane fuel cells (PEM fuel cells) are known in the prior art. Virtually exclusively polymers modified with sulfonic acid are used at present as proton-conducting membrane in them. Here, predominantly perfluorinated polymers are employed. A prominent example is Nafion® from DuPont. A relatively high water content of typically from 4 to 20 molecules of water per sulfonic acid group in the membrane is necessary for proton conduction. The required water content and also the stability of the polymer in the presence of acidic water and the reaction gases hydrogen and oxygen usually limits the operating temperature of the PEM fuel cell stack to 80-100° C. Under superatmospheric pressure, the operating temperature can be increased to >120° C. Otherwise, higher operating temperatures cannot be realized without a loss in performance of the fuel cell.

However, operating temperatures higher than 100° C. in the fuel cell are desirable for system reasons. The activity of the noble metal-based catalysts comprised in the membrane-electrode assembly is significantly better at high operating temperatures. Particularly when reformates from hydrocarbons are used, significant amounts of carbon monoxide are comprised in the reformer gas and these usually have to be removed by means of a complicated gas work-up or gas purification. At high operating temperatures, the tolerance of the catalysts to the CO impurities increases.

Furthermore, heat is evolved during operation of fuel cells. However, cooling of the systems to below 80° C. can be very complicated. Depending on the power output, the cooling devices can be made substantially simpler. This means that in fuel cells which are operated at temperatures above 100° C., the heat involved can be utilized significantly more readily and the fuel cell system efficiency can thus be increased by power-heat coupling. To achieve these temperatures, membranes having new conductivity mechanisms are generally required. A promising approach which can be realized in a fuel cell which operates at operating temperatures of >100° C., in general from 120° C. to 180° C., with no or very little moistening relates to a fuel cell type in which the conductivity of the membrane is based on the content of liquid acid which is bound electrostatically to the polymer framework of the membrane and takes over proton conductivity without additional humidification of the operating gases even when the membrane is virtually completely dry above the boiling point of water. Such a fuel cell type as is known from the prior art is generally referred to as a high-temperature polymer electrolyte membrane fuel cell (HTM fuel cell). Polybenzimidazole (PBI), in particular, is known as material for such membranes which are, for example, impregnated with phosphoric acid as liquid electrolyte.

To obtain a very high efficiency of membranes impregnated with an acidic liquid electrolyte, the electrodes used in a membrane-electrode assembly or in a fuel cell have to be matched to the conditions in the fuel cell membrane. It is important here that, inter alia, the acid loss (loss of the liquid electrolyte) during operation of the cell is very low and the concentration of free acid in the electrode is likewise very low.

DE 10 2004 063457 A1 describes a membrane-electrode assembly comprising a fuel cell membrane which is arranged between two gas diffusion layers, with the fuel cell membrane being based on an acid-impregnated polymer. According to DE 10 2004 063457 A1, at least one catalyst-comprising layer having an addition of polymer is in each case arranged between the fuel cell membrane and the gas diffusion layers so that water is retained and/or acid is stored in the membrane-electrode assembly and/or the fuel cell membrane. Polyazoles are usually used as polymers according to DE 10 2004 063457 A1. The membrane-electrode assembly is produced by producing an electrode paste from a pulverulent catalyst, solvent, a pore-forming material and a polymer solution and applying this to the membrane by screen printing. The polymer content in the electrode paste is, according to DE 10 2004 063457, from 0.001 to 0.06% by weight, based on 1 g of catalyst paste. The method described in DE 10 2004 063457 A1 does not make it possible to apply the addition of polymer, in particular polyazole, to the catalyst or the polymer electrolyte membrane in a controlled, targeted fashion.

WO 2006/005466 discloses a gas diffusion electrode having improved proton conduction between an electrocatalyst present in a catalyst layer and an adjacent polymer electrolyte membrane which can be used at operating temperatures up to above the boiling point of water and ensures lasting high gas permeability. Here, at least part of the particles of an electrically conductive support material in the catalyst layer is loaded with at least one porous proton-conducting polymer which can be used to above the boiling point of water. The loading of the polymer is effected, according to WO 2006/005466, by means of phase inversion processes as a result of which, according to WO 2006/005466, good proton conduction between catalyst and membrane is achieved. The catalyst layer preferably additionally comprises porous particles of a proton-conducting polymer, especially an N-comprising polymer. According to WO 2006/005466, such a polymer can absorb and fix dopants, e.g. phosphoric acid.

EP 0 731 520 A1 discloses a catalyst ink comprising one or more catalysts, one or more proton-conducting polymers, preferably fluorinated polymers having ion-exchange groups, which is/are added as a solution in an organic solvent, in an aqueous medium based on water which is free of organic components.

In view of the abovementioned prior art, it is an object of the present invention to provide a catalyst ink which is suitable for producing electrodes and membrane-electrode assemblies and also fuel cells, where the fuel cells are suitable for use at high temperatures (high-temperature fuel cells) and an increase in the three-phase interfacial area (catalyst, ionomer and gas), a reduction in the concentration of free acid in the electrode, a reduction in or avoidance of the acid loss during operation of the cell and a reduction in the cell resistance can be achieved by use of a specific catalyst ink. This object is achieved by a catalyst ink comprising:
(a) one or more catalyst materials as component A,
(b) a liquid medium as component B, and
(c) polymer particles comprising one or more proton-conducting polymers as component C.

It is important that the catalyst ink according to the present patent application does not comprise any solution of polymers but rather polymer particles which are dispersed in the liquid medium of the catalyst ink.

The catalyst ink according to the invention can be applied by known standard methods, e.g. screen printing, doctor blade application, other printing processes, spray coating, to the gas diffusion layers or membranes.

The catalyst ink of the invention is, as mentioned above, particularly suitable for high-temperature fuel cells in which the conductivity of the membrane is based on the content of a liquid acid which is electrostatically bound to the polymer framework of the membrane, with the membrane being particularly preferably based on polyazoles and, for example, phosphoric acid being used as liquid electrolyte.

The acid, in particular phosphoric acid, can be absorbed by the polymer particles which are finely dispersed in the catalyst layer and be bound to the polymer particles present in the catalyst layer. This enables the three-phase interfacial area (catalyst, ionomer and gas) to be increased. It has been found that a membrane-electrode assembly based on a catalyst ink according to the invention has lower resistances compared to a membrane-electrode assembly based on a catalyst ink which does not comprise any finely dispersed polymer. This is surprising since a person skilled in the art would have expected that swelling of the polymer particles comprised in the catalyst ink would leave less room for gas and materials transport and poorer properties of the membrane-electrode assembly would thus be expected.

A significant difference from the catalyst ink which is disclosed in DE 10 2004 063457 A1 is that the polymer in the catalyst ink of the present invention is present not as a solution but as finely dispersed particles. As a result, the catalyst is not coated with the polymer and higher proportions of polymer can therefore be used and the activity of the catalyst is not reduced. As a result, correspondingly more acid can be bound.

### Component A: Catalyst Materials

According to the present invention, the catalyst ink comprises one or more catalyst materials as component A. These catalyst materials serve as catalytically active components. Suitable catalyst materials which can be used as catalyst materials for the anode or for the cathode of a membrane-electrode assembly or a fuel cell are known to those skilled in the art. For example, suitable catalyst materials are ones which comprise at least one noble metal as catalytically active component, in particular platinum, palladium, rhodium, iridium and/or ruthenium. These substances can also be used in the form of alloys with one another. Furthermore, the catalytically active component can comprise one or more base metals as alloying additives, with these being selected from the group consisting of chromium, zirconium, nickel, cobalt, titanium, tungsten, molybdenum, vanadium, iron and copper. Furthermore, the oxides of the abovementioned noble metals and/or base metals can also be used as catalyst materials.

The catalyst material can be present in the form of supported catalysts or support-free catalysts, with supported catalysts being preferred. As support materials, preference is given to using electrically conductive carbon, particularly preferably selected from among carbon blacks, graphite and activated carbons.

The catalyst materials are generally used in the form of particles. When the catalyst materials are present as support-free catalysts, the particles (e.g. noble metal crystallites) can have average particle sizes of <5 nm, e.g. from 1 to 1000 nm, determined by means of XRD measurements. When the catalyst material is used in the form of supported catalysts, the particle size (catalytically active component+support material) is generally from 0.01 to 100 μm, preferably from 0.01 to 50 μm, particularly preferably from 0.01 to 30 μm.

In general, the catalyst ink of the present invention comprises such a proportion of noble metals that the noble metal content in the catalyst layer of the electrode or membrane-electrode assembly produced by means of the catalyst ink is from 0.1 to 10.0 mg/cm², preferably from 0.2 to 6.0 mg/cm², particularly preferably from 0.2 to 3.0 mg/cm². These values can be determined by elemental analysis of a sheet-like specimen.

In the production of a membrane-electrode assembly using the catalyst ink of the invention, it is usual to select a weight ratio of a membrane polymer for producing the membrane present in the membrane-electrode assembly to the catalyst material comprising at least one noble metal and, if appropriate, one or more support materials used in the catalyst ink of >0.05, preferably from 0.1 to 0.6.

In the catalyst ink of the invention, the catalyst materials (component A) are generally present in an amount of from 2 to 30% by weight, preferably from 2 to 25% by weight, particularly preferably from 3 to 20% by weight, based on the total amount of catalyst ink.

When the catalyst materials used according to the invention comprise a support material, the proportion of support material in the catalyst materials used according to the invention is generally from 40 to 90% by weight, preferably from 60 to 90% by weight. The proportion of noble metal in the catalyst materials used according to the invention is generally from 10 to 60% by weight, preferably from 10 to 40% by weight. If a base metal is used as alloying additive in addition to the noble metal, the proportion of noble metal is reduced by the corresponding amount of the base metal. The proportion of base metal as alloying additive, based on the total amount of metal present in the catalyst material, is usually from 0.5 to 15% by weight, preferably from 1 to 10% by weight. If the corresponding oxides are used instead of the metals, the amounts indicated for the metals apply.

### Component B: Liquid Medium

In general, the catalyst ink of the invention comprises from 4 to 30% by weight of solids, i.e. component A and component C, preferably from 5 to 25% by weight of solids.

As liquid medium in the catalyst ink of the invention, use is generally made of an aqueous medium, preferably water. In addition to water, the aqueous medium can comprise alcohols or polyalcohols such as glycerol or ethylene glycol or organic solvents such as dimethylacetamide (DMAc), N-methylpyrrolidone (NMP) or dimethylformamide (DMF). The water, alcohol or polyalcohol content and/or the content of organic solvent in the catalyst ink can be selected so as to set the rheological properties of the catalyst ink. In general, the catalyst ink of the invention comprises from 0 to 50% by weight of alcohol and/or from 0 to 20% by weight of polyalcohol and/or from 0 to 50% by weight of at least one organic solvent in addition to water.

The liquid medium can optionally comprise additional components which lead to the liquid medium being acidic or alkaline, preferably acidic. Suitable components are known to those skilled in the art.

### Component C: Polymer Particles Comprising One or More Proton-Conducting Polymers

As component C, the catalyst ink of the invention comprises polymer particles comprising one or more proton-conducting polymers.

For the purposes of the present invention, proton-conducting polymers are polymers which together with a liquid comprising acids or acid-comprising compounds as electrolyte can conduct protons.

Suitable polymers which can conduct protons in the presence of acids or acid-comprising compounds as electrolytes are, for example, selected from the group consisting of poly(phenylene), poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidine, polyvinylpyridine;

polymers having CO bonds in the main chain, for example polyacetal, polyoxymethylene, polyether, polypropylene oxide, polyether ketone, polyester, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
polymers having C—S bonds in the main chain, for example polysulfide ether, polyphenylene sulfide, polysulfones, polyether sulfone;
polymers having C—N bonds in the main chain, for example polyimines, polyisocyanides, polyetherimine, polyetherimide, polyaniline, polyaramids, polyamides, polyhydrazides, polyurethanes, polyimides, polyazoles, polyazole ether ketone, polyazines;
liquid-crystalline polymers, in particular Vectra® from Ticona GmbH and also
inorganic polymers, for example polysilanes, polycarbosilanes, polysiloxanes, polysilicic acid, polysilicates, silicones, polyphosphazenes and polythiazyl.

Preference is given here to basic polymers, with possible polymers in principle being all basic polymers by means of which, after acid doping, protons can be transported. Acids which are preferably used are those which can transport protons without addition of water, e.g. by means of the Grotthos mechanism.

As basic polymer, preference is given, according to the present invention, to using a basic polymer having at least one nitrogen, oxygen or sulfur atom, preferably at least one nitrogen atom, in a repeating unit. Furthermore, preference is given to basic polymers which comprise at least one heteroaryl group.

The repeating unit in the basic polymer comprises, in a preferred embodiment, an aromatic ring having at least one nitrogen atom. The aromatic ring is preferably a 5- or 6-membered ring which has from 1 to 3 nitrogen atoms and can be fused with another ring, in particular another aromatic ring.

In a preferred embodiment, high-temperature-stable polymers which comprise at least one nitrogen, oxygen and/or sulfur atom in one repeating unit or in different repeating units are used.

For the purposes of the present invention, a high-temperature-stable polymer is a polymer which can be operated as polymeric electrolyte in a fuel cell at temperatures above 120° C. on a long-term basis. A long-term basis means that a membrane composed of this polymer can generally be operated for at least 100 hours, preferably at least 500 hours, at least 80° C., preferably at least 120° C., particularly preferably at least 160° C., without the power, which can be measured by the method described in WO 01/18894 A2, decreasing by more than 50%, based on the initial power.

For the purposes of the present invention, all abovementioned polymers can be used individually or as a mixture (blend). Here, particular preference is given to blends comprising polyazoles and/or polysulfones. The preferred blend components here are polyether sulfone, polyether ketone and polymers modified with sulfonic acid groups, as described in DE 100 522 42 and DE 102 464 61.

Furthermore, polymer blends comprising at least one basic polymer and at least one acidic polymer, preferably in a weight ratio of from 1:99 to 99:1, (known as acid-base polymer blends) have also been found to be useful for the purposes of the present invention. In this context, particularly useful acidic polymers comprise polymers which have sulfonic acid and/or phosphoric acid groups. Acid-base polymer blends which are very particularly suitable for the purposes of the invention are described, for example, in EP 1 073 690 A1.

The polymer particles comprising one or more proton-conducting polymers are very particularly preferably polyazoles or mixtures of polyazoles which are doped with acid, preferably phosphoric acid, to make them proton-conducting.

A basic polymer based on polyazole particularly preferably comprises recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII):

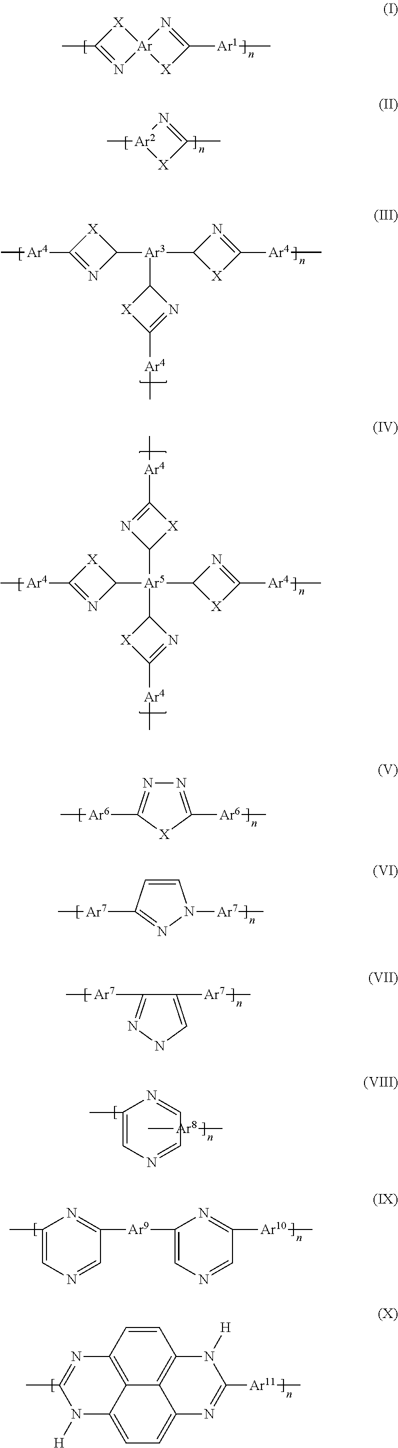

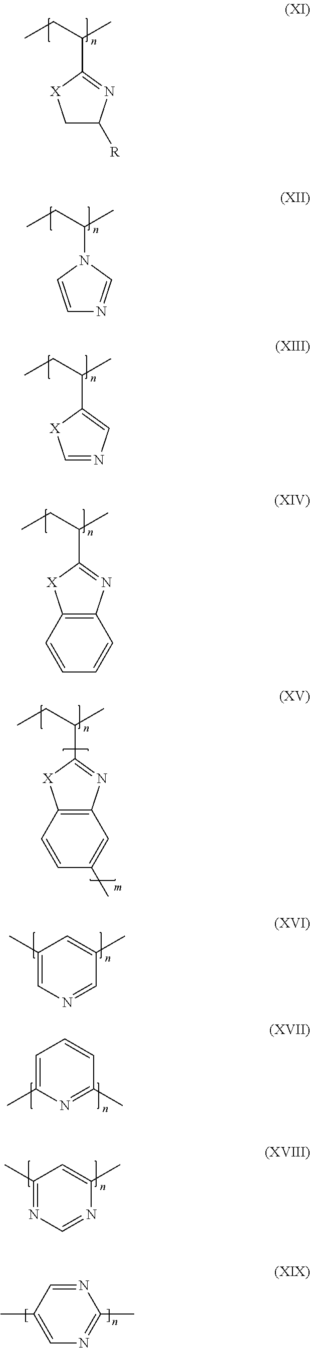

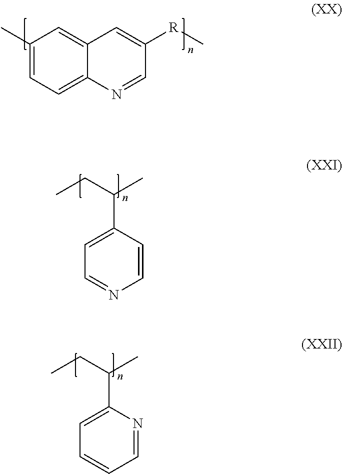

where
the radicals Ar are identical or different and are each a tetravalent aromatic or heteroaromatic group which may be monocyclic or polycyclic,
the radicals Ar¹ are identical or different and are each a divalent aromatic or heteroaromatic group which may be monocyclic or polycyclic,
the radicals Ar² are identical or different and are each a divalent or trivalent aromatic or heteroaromatic group which may be monocyclic or polycyclic,
the radicals Ar³ are identical or different and are each a trivalent aromatic or heteroaromatic group which may be monocyclic or polycyclic,
the radicals Ar⁴ are identical or different and are each a trivalent aromatic or heteroaromatic group which may be monocyclic or polycyclic,
the radicals Ar⁵ are identical or different and are each a tetravalent aromatic or heteroaromatic group which may be monocyclic or polycyclic,
the radicals Ar⁶ are identical or different and are each a divalent aromatic or heteroaromatic group which may be monocyclic or polycyclic,
the radicals Ar⁷ are identical or different and are each a divalent aromatic or heteroaromatic group which may be monocyclic or polycyclic,
the radicals Ar⁸ are identical or different and are each a trivalent aromatic or heteroaromatic group which may be monocyclic or polycyclic,
the radicals Ar⁹ are identical or different and are each a divalent or trivalent or tetravalent aromatic or heteroaromatic group which may be monocyclic or polycyclic,
the radicals Ar¹⁰ are identical or different and are each a divalent or trivalent aromatic or heteroaromatic group which may be monocyclic or polycyclic,
the radicals Ar¹¹ are identical or different and are each a divalent aromatic or heteroaromatic group which may be monocyclic or polycyclic,
the radicals X are identical or different and are each oxygen, sulfur or an amino group which bears a hydrogen atom, a group having from 1 to 20 carbon atoms, preferably a branched or unbranched alkyl or alkoxy group, or an aryl group as further radical,
the radicals R are identical or different and are each hydrogen, an alkyl group or an aromatic group and in formula (XX) an alkylene group or an aromatic group, with the proviso that R in formula (XX) is not hydrogen, and
n, m are each an integer≧10, preferably ≧100.

Preferred aromatic or heteroaromatic groups are derived from benzene, naphthalene, biphenyl, diphenyl ether, diphenylmethane, diphenyldimethylmethane, bisphenone, diphenyl sulfone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine, benzopyrazidine, benzopyrimidine, benzotriazine, indolizine, quinolizine, pyridopyridine, imidazolopyrimidine, pyrazinopyrimidine, carbazole, azeridine, phenazine, benzoquinoline, phenoxazine, phenothiazine, aziridizine, benzopteridine, phenanthroline and phenanthrene, which may optionally be substituted.

Here, the substitution pattern of Ar¹, Ar⁴, Ar⁶, Ar⁷, Ar⁸, Ar⁹, Ar¹⁰ and Ar¹¹ can be any desired pattern. In the case of phenylene, for example, Ar¹, Ar⁴, Ar⁶, Ar⁷, Ar⁸, Ar⁹, Ar¹⁰ and Ar¹¹ can be, independently of one another, ortho-, meta- and para-phenylene. Particularly preferred groups are derived from benzene and biphenylene, which may optionally be substituted.

Preferred alkyl groups are alkyl groups having from 1 to 4 carbon atoms, e.g. methyl, ethyl, n-propyl, i-propyl and t-butyl groups.

Preferred aromatic groups are phenyl or naphthyl groups. The alkyl groups and the aromatic groups may be monosubstituted or polysubstituted.

Preferred substituents are halogen atoms, e.g. fluorine, amino groups, hydroxy groups or C₁-C₄-alkyl groups, e.g. methyl or ethyl groups.

The polyazoles can in principle have differing recurring units which differ, for example, in their radical X. However, the respective polyazoles preferably have exclusively identical radicals X in a recurring unit.

In a particularly preferred embodiment of the present invention, the polyazole salt is based on a polyazole comprising recurring azole units of the formula (I) and/or (II).

The polyazoles used to form the polyazole salts are, in one embodiment, polyazoles comprising recurring azole units in the form of a copolymer or a blend comprising at least two units of the formulae (I) to (XXII) which are different from one another. The polymers can be present as block copolymers (diblock, triblock), random copolymers, periodic copolymers and/or alternating polymers.

The number of recurring azole units in the polymer is preferably an integer≧10, particularly preferably ≧100.

In a further preferred embodiment, polyazoles which comprise recurring units of the formula (I) and in which the radicals X are identical within the recurring unit are used as polyazoles for forming the polyazole salt.

Further preferred polyazoles on which the polyazole salts of the present invention are based are selected from the group consisting of polybenzimidazole, poly(pyridine), poly(pyrimidine), polyimidazole, polybenzthiazole, polybenzoxazole, polyoxadiazole, polyquinoxaline, polythiadiazole and poly(tetrazapyrene).

In a particularly preferred embodiment, the polyazole salt is based on a polyazole comprising recurring benzimidazole units. Suitable polyazoles having recurring benzimidazole units are shown below:

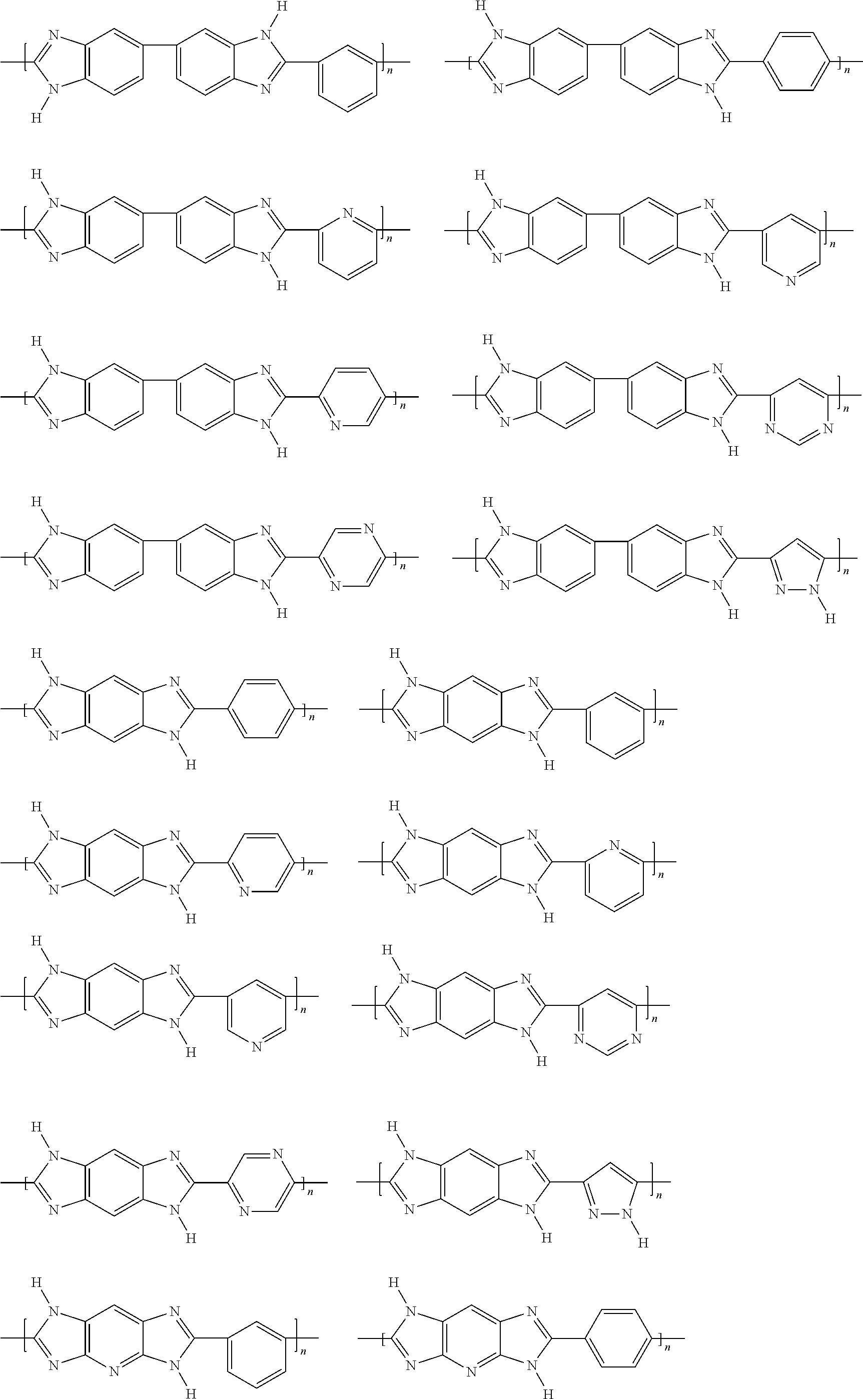

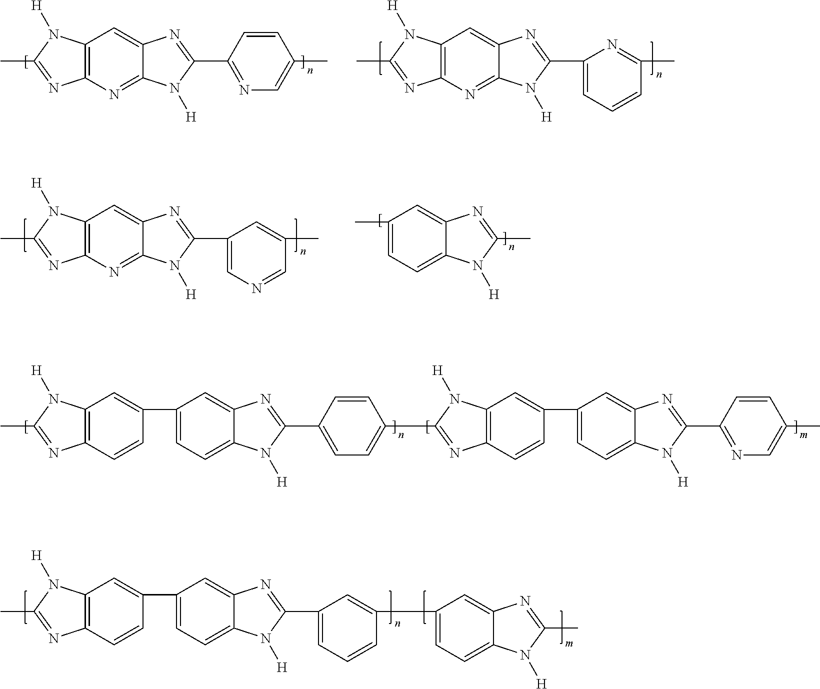

where n and m are integers≧10, preferably ≧100;
where the phenylene or heteroarylene units present in the above-mentioned benzimidazole units may be substituted by one or more F atoms.

The polyazole on which the polyazole salt used according to the invention is based particularly preferably has repeating units of the following formula

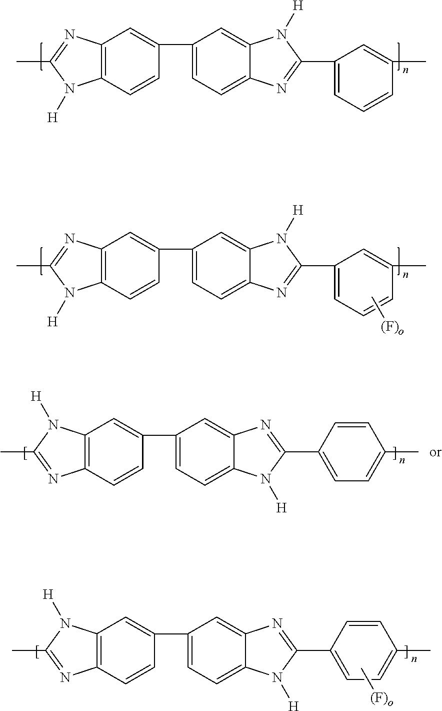

where n is an integer≧10, preferably ≧100, and o is 1, 2, 3 or 4.

The polyazoles, preferably the polybenzimidazoles, generally have a high molecular weight. Measured as intrinsic viscosity, the molecular weight is preferably at least 0.2 dl/g, particularly preferably from 0.8 to 10 dl/g, very particularly preferably from 1 to 10 dl/g. The viscosity eta i, also referred to as intrinsic viscosity, is calculated from the relative viscosity eta rel according to the following equation

eta i=(2.303×log eta rel)/concentration. The concentration is given in g/100 ml. The relative viscosity of the polyazoles is determined by means of a capillary viscometer from the viscosity of the solution at 25° C., with the relative viscosity being calculated from the corrected run-out times for solvent t0 and solution t1 according to the following equation eta rel=t1/t0. The conversion into eta i is carried out according to the above relationship by the procedure in “Methods in Carbohydrate Chemistry”, Volume IV, Starch, Academic Press, New York and London, 1964, page 127.

Preferred polybenzimidazoles are commercially available, for example, under the trade name Celazol® PBI (from PBI Performance Products Inc.).

In a very particularly preferred embodiment, the proton-conducting polymer is pPBI (poly-2,2′-p-(phenylene)-5,5′-dibenzimidazole and/or F-pPBI (poly-2,2′-p-(perfluorophenylene)-5,5′-dibenzimidazole), which is proton-conducting after doping with acid.

An essential element of the catalyst ink of the invention is that the proton-conducting polymer(s) is/are present in the form of polymer particles (usually in the form of a dispersion) in the catalyst ink. The polymer particles generally have an average particle size of ≦100 μm, preferably ≦50 μm. The particle size and particle size distribution are determined by laser light scattering using a Malvern Master Sizer® instrument.

A suitable method of determining the particle size and particle size distribution by means of laser light scattering is given below:

Material: catalyst ink
Dispersion medium: deionized water
Preparation: dilute about 0.3 ml of original suspension in 2 ml of deionized water and stir, then add about 0.5 ml to 125 ml of deionized water on the measuring instrument, corresponds to a light attenuation of about 20%
Measuring instrument: Mastersizer® 2000 laser light scattering instrument from Malvern
Dispersing module: Hydro S: pump=3000 rpm, without and with USW=100% about 5 min.
Analytical model: Universal
Evaluation model: Fraunhofer model
Measurement range: from 20 nm to 2000 μm.
typical concentration range 10⁻²<cv<10⁻⁴.
   Measurement method: The intensities at the detector elements are converted into a particle size distribution by inversion of the Fraunhofer scattering and reported as volume distribution.
   Measurements: With red light source (wavelength=633 nm) and blue light source (wavelength=466 nm).

The catalyst ink of the invention usually comprises from 1 to 50% by weight, preferably from 1 to 30% by weight, particularly preferably from 1 to 15% by weight, of the at least one proton-conducting polymer, based on the amount of catalyst material used in the ink.

The catalyst ink of the invention can, if appropriate, further comprise at least one dispersant as component D. The dispersant is generally present in an amount of from 0.1 to 4% by weight, preferably from 0.1 to 3% by weight, based on the proton-conducting polymer. Suitable dispersants are known in principle to those skilled in the art. A particularly preferred dispersant used as component D is at least one perfluorinated polymer, e.g. at least one tetrafluoroethylene polymer, preferably at least one perfluorinated sulfonic acid polymer, e.g. at least one sulfonated tetrafluoroethylene polymer, particularly preferably Nafion® from DuPont, Fumion® from Fumatech or Ligion® from Ionpower.

In a further preferred embodiment, the present invention therefore provides a catalyst ink according to the invention which further comprises a component D as dispersant:
(d) at least one perfluorinated polymer, e.g. at least one tetrafluoroethylene polymer, preferably at least one perfluorinated sulfonic acid polymer, e.g. at least one sulfonated tetrafluoroethylene polymer, particularly preferably Nafion® from DuPont, Fumion® from Fumatech or Ligion® from Ionpower.

Further suitable perfluorinated polymers are, for example, tetrafluoroethylene-polymer (PTFE), polyvinylidene fluoride (PVdF), perfluoro(propyl vinyl ether) (PFA) and/or perfluoro(methyl vinyl ether) (MFA).

In addition, the catalyst ink of the invention can further comprise at least one surfactant as component E. Suitable surfactants are known to those skilled in the art. They can be surfactants which, after application of the catalyst ink, are either washed out or decompose pyrolytically, e.g. when the electrode produced by application of the catalyst ink is heated, for example, to temperatures of <200° C. Preferred surfactants are selected from the group consisting of anionic surfactants and nonionic surfactants, e.g. fluorosurfactants such as surfactants of the general formula CF₃—(CF₂)ₚ—X, where p=3 to 12 and X is selected from the group consisting of —SO₃H, —PO₃H₂ and —COOH, e.g. a tetraethylammonium salt of heptadecafluoroctanoic acid. Further suitable surfactants are octylphenolpoly(ethylene glycol ether)ₓ, where x can be, for example, 10, e.g. Triton® X-100 from Roche Diagnostics GmbH, nonylphenol ethoxylates, e.g. nonylphenol ethoxylates of the Tergitol® series of Dow Chemical Company, sodium salts of naphthalenesulfonic acid condensates, e.g. sodium salts of naphthalenesulfonic acid condensates of the Tamol® series of BASF SE, fluorosurfactants, e.g. fluorosurfactants of the Zonyl® series of DuPont, alkoxylation products of predominantly linear fatty alcohols, e.g. of the Plurafac® series, e.g. Plurafac® LF 711 from BASF SE, alkoxylates of ethylene oxide or propylene oxide, e.g. alkoxylates of ethylene oxide or propylene oxide of the Pluriol® series of BASF SE, in particular polyethylene glycols of the formula HO(CH₂CH₂O)ₙH, e.g. of the Pluriol® E series of BASF SE, e.g. Pluriol® E300, and β-naphthol ethoxylate, e.g. Lugalvan® BNO12 from BASF SE.

The at least one surfactant is, when surfactant is used, usually used in an amount of from 0.1 to 4% by weight, preferably from 0.1 to 3% by weight, particularly preferably from 0.1 to 2.5% by weight, based on the total amount of the catalyst ink.

The present invention therefore further provides a catalyst ink according to the invention which further comprises a component E:
(e) at least one surfactant, preferably selected from the group consisting of anionic surfactants, e.g. fluorosurfactants such as surfactants of the general formula CF₃—(CF₂)ₚ—X, where p=3 to 12 and X is selected from the group consisting of —SO₃H, —PO₃H₂ and —COOH, e.g. a tetraethylammonium salt of heptadecafluoroctanoic acid. Further suitable surfactants are octylphenolpoly(ethylene glycol ether)ₓ, where x can be, for example, 10, e.g. Triton® X-100 from Roche Diagnostics GmbH, nonylphenol ethoxylates, e.g. nonylphenol ethoxylates of the Tergitol® series of Dow Chemical Company, sodium salts of naphthalenesulfonic acid condensates, e.g. sodium salts of naphthalenesulfonic acid condensates of the Tamol® series of BASF SE, fluorosurfactants, e.g. fluorosurfactants of the Zonyl® series of DuPont, alkoxylation products of predominantly linear fatty alcohols, e.g. of the Plurafac® series, e.g. Plurafac® LF 711 from BASF SE, alkoxylates of ethylene oxide or propylene oxide, e.g. alkoxylates of ethylene oxide or propylene oxide of the Pluriol® series of BASF SE, in particular polyethylene glycols of the formula HO(CH₂CH₂O)ₙH, e.g. of the Pluriol® E series of BASF SE, e.g. Pluriol® E300, and β-naphthol ethoxylate, e.g. Lugalvan® BNO12 from BASF SE.

The catalyst ink of the invention is produced by simple mixing of the components A, B and C and optionally the components D and optionally E. Mixing can be carried out in customary mixing apparatuses, with customary mixing apparatuses being known to those skilled in the art. This mixing can be carried out by all methods known to those skilled in the art in the apparatuses known to those skilled in the art, e.g. in stirred vessels, ball shaking mixers or continuous mixing apparatuses, if appropriate using ultrasound. Mixing of the components of the catalyst ink is usually carried out at room temperature. However, it is possible to mix the components of the catalyst ink in a temperature range from 0 to 70° C., preferably from 10 to 50° C.

The catalyst ink of the invention is suitable for producing electrodes, membrane-electrode assemblies and for producing fuel cells and fuel cell stacks.

Use of the catalyst ink of the invention makes it possible to achieve an increase in the three-phase interfacial area (catalyst, ionomer and gas), a reduction in the concentration of a free acid in the electrode, a reduction or decrease in the acid loss during operation of the cell and also a reduction of the cell resistance.

The present invention further provides a membrane-electrode assembly produced using the catalyst ink of the invention.

According to the invention, the membrane-electrode assembly comprises at least two electrochemically active electrodes (anode and cathode) which are separated by a polymer electrolyte membrane, with the electrodes being obtained by application of a catalyst ink according to the invention. The term “electrochemically active” indicates that the electrodes are able to catalyze the oxidation of hydrogen and/or at least one reformate and the reduction of oxygen. The term “electrode” means that the material is electrically conductive.

According to the present invention, the membrane-electrode assembly preferably further comprises gas diffusion layers which are in each case in contact with a catalyst layer forming the electrodes.

As gas diffusion layers, use is usually made of sheet-like, electrically conducting and acid-resistant structures. These include, for example, graphite fiber papers, carbon fiber papers, woven graphite fabric and/or papers which are made conductive by addition of carbon black. A fine dispersion of the gas or liquid streams is achieved by means of these layers.

Furthermore, it is also possible to use gas diffusion layers which comprise a mechanically stable support material which is impregnated with at least one electrically conductive material, e.g. carbon (for example carbon black). Support materials which are particularly suitable for these purposes comprise fibers, for example in the form of nonwovens, papers or woven fabrics, in particular carbon fibers, glass fibers or fibers comprising organic polymers, for example polypropylene, polyester (polyethylene terephthalate), polyphenylene sulfide or polyether ketones. Further details of such diffusion layers may be found, for example, in WO 97/20358.

The gas diffusion layers preferably have a thickness in the range from 80 μm to 2000 μm, particularly preferably from 100 μm to 1000 μm, very particularly preferably from 150 μm to 500 μm.

Furthermore, the gas diffusion layers advantageously have a high porosity. This is preferably in the range from 20% to 80%.

The gas diffusion layers can comprise customary additives. These include, inter alia, fluoropolymers, for example polytetrafluoroethylene (PTFE), and surface-active substances.

In one embodiment, at least one of the gas diffusion layers can comprise a compressible material. For the purposes of the present invention, a compressible material has the property that the gas diffusion layer can be pressed by means of applied pressure to at least half, preferably at least one third, of its original thickness without losing its integrity.

This property is generally displayed by gas diffusion layers composed of woven graphite fabrics and/or paper which has been made conductive by addition of carbon black.

As polymer electrolyte membrane in the fuel cell of the invention, it is in principle possible to use all polymer electrolyte membranes known to those skilled in the art. The polymer electrolyte membrane is preferably made up of at least one of the materials mentioned in respect of the polymer particles (component C). The polymer electrolyte membrane is therefore, in a particularly preferred embodiment, a polyazole membrane which has been made proton-conducting by addition of acid, in particular phosphoric acid. Further embodiments of suitable materials for the polyazole membrane correspond to the materials mentioned in respect of component C.

The polymer electrolyte membrane is produced by methods known to those skilled in the art, e.g. by casting, spraying or doctor blade application of a solution or dispersion comprising the components used for producing the polymer electrolyte membrane to a support. Suitable supports are all customary support materials known to those skilled in the art, e.g. polymeric materials such as polyethylene terephthalate (PET) or polyether sulfone or a metal tape, with the membrane subsequently being able to be detached from the metal tape.

The polymer electrolyte membrane used in the membrane-electrode assemblies of the invention generally has a layer thickness of from 20 to 4000 μm, preferably from 30 to 3500 μm, particularly preferably from 50 to 3000 μm.

The catalyst layer (electrode) of the membrane-electrode assembly of the invention, which is formed on the basis of the catalyst ink of the invention, is generally not self-supporting, but rather is usually applied to the gas diffusion layer and/or the polymer electrolyte membrane. Here, part of the catalyst layer can, for example, diffuse into the gas diffusion layer and/or the membrane, forming transition layers. This can also lead to the catalyst layer being able to be conceived of as part of the gas diffusion layer.

The catalyst layer (electrode) can thus be produced by various methods, e.g. by gas diffusion electrodes being produced first by coating a gas diffusion layer with the catalyst ink of the invention. The membrane-electrode assembly is then produced by heating and pressing of the polymer electrolyte membrane and the gas diffusion layer coated with the electrode.

However, it is also possible for the catalyst ink to be applied to the surface of a polymer electrolyte membrane so that the electrodes are formed on the polymer electrolyte membrane.

Application of the catalyst ink either to the polymer electrolyte membrane or the gas diffusion layer can be effected by all methods known to those skilled in the art, e.g. spraying, printing, doctor blade application, decal, screen printing or inkjet printing.

The catalyst layer obtained generally has a thickness of from 1 to 1000 μm, preferably from 5 to 500 μm, particularly preferably from 10 to 300 μm. This value represents an average which can be determined by measurement of the layer thickness in cross section on micrographs which can be obtained by means of a scanning electron microscope (SEM).

The present invention therefore further provides a membrane-electrode assembly comprising at least two electrochemically active electrodes separated by a polymer electrolyte membrane, wherein the at least two electrochemically active electrodes are obtained by application of the catalyst ink of the invention to the polymer electrolyte membrane. Suitable methods of applying the catalyst ink of the invention to the polymer electrolyte membrane and also suitable layer thicknesses of the catalyst layer obtained have been mentioned above.

In the membrane-electrode assembly of the invention, the surfaces of the polymer electrolyte membrane are in contact with the electrodes in such a way that the first electrode covers the front side of the polymer electrolyte membrane and the second electrode covers the rear side of the polymer electrolyte membrane, in each case partially or completely, preferably only partially. Here, the front and rear sides of the polymer electrolyte membrane are the sides of the polymer electrolyte membrane facing toward and away from, respectively, the viewer, with the view being from the first electrode (front), preferably the cathode, in the direction of the second electrode (behind), preferably the anode.

The catalyst inks used for applying the anode or the cathode of the membrane-electrode assembly of the invention can be identical or different. A person skilled in the art will know which noble metals and further components should be present, in particular, in the catalyst ink for producing the anode and for producing the cathode.

For further information regarding suitable polymer electrolyte membranes and on the structure and the production of membrane-electrode assemblies, reference may be made to the documents WO 01/18894 A2, DE 195 097 48, DE 195 097 49, WO 00/26982, WO 92/15121 and DE 197 574 92.

The production of the membrane-electrode assemblies of the invention is in principle known to those skilled in the art. The various constituents of the membrane-electrode assembly are usually placed on top of one another and joined to one another by means of pressure and heat, with lamination usually being carried out at a temperature of from 10 to 300° C., preferably from 20 to 200° C., and at a pressure of generally from 1 to 1000 bar, preferably from 3 to 300 bar.

An advantage of the membrane-electrode assemblies of the invention is that they make it possible for the fuel cell to be operated at temperatures above 120° C. This is true for gaseous and liquid fuels such as hydrogen-comprising gases which are, for example, produced in a preceding reforming step from hydrocarbons. As oxidant, it is possible to use, for example, oxygen or air.

A further advantage of the membrane-electrode assemblies of the invention is that in operation above 120° C. even when using pure platinum catalysts, i.e. without a further alloying constituent, they have a high tolerance toward carbon monoxide. At temperatures of 160° C., it is possible for, for example, more than 1% of CO to be comprised in the fuel gas without this leading to an appreciable reduction in the performance of the fuel cell.

Preferred membrane-electrode assemblies comprising, for example, a polyazole membrane can be operated in fuel cells without the fuel gases and the oxidants having to be humidified despite the possible operating temperatures. The fuel cell nevertheless operates stably and the membrane does not lose its conductivity. This simplifies the entire fuel cell system and brings additional cost savings since the water circuit is simplified. Furthermore, the behavior of the fuel cell system at temperatures below 0° C. is also improved as a result.

The present invention further provides a fuel cell comprising at least one membrane-electrode assembly according to the present invention. Suitable fuel cells are known to those skilled in the art.

Since the power of a single fuel cell is often too low for many applications, it is usual, for the purposes of the present invention, to combine a plurality of single fuel cells via separator plates to form a fuel cell stack. The separator plates should, if appropriate together with further sealing materials, seal the gas spaces of the cathode and the anode from the outside and seal the gas spaces of the cathode and the anode from one another. For this purpose, the separator plates are preferably juxtaposed in a sealing fashion with the membrane-electrode assembly. The sealing effect can be increased further by pressing of the combination of separator plates and membrane-electrode assembly.

The separator plates preferably each have at least one gas channel for reaction gases, which gas channels are advantageously arranged on the sides facing the electrodes. The gas channels should make distribution of the reactant fluids possible.

The present invention further provides for the use of the catalyst ink of the invention for producing a membrane-electrode assembly. Suitable production processes and components of the membrane-electrode assembly and components of the catalyst ink have been described above. The examples below illustrate the invention.

### EXAMPLES

### Production of a Catalyst Ink

2.4 parts of Nafion® ionomer (perfluorosulfonic acid polymer) in H₂O (10 wt %) EW1100 (from DuPont), 1.85 parts of H₂O and x parts (see Table 1) of polymer powder are placed in a glass flask and stirred by means of a magnetic stirrer. One part of Pt/C catalyst is then weighed in and slowly mixed into the batch while stirring. The batch is stirred further for about 5-10 minutes at room temperature by means of the magnetic stirrer. The sample is then treated with ultrasound until the amount of energy introduced is 0.015 KWh. This value is based on a batch size of 20 g.

TABLE 1
Polymer components in the catalyst ink:

| Polymer powder | x parts |
|---|---|
| Comparative sample | 0 |
| pPBI [poly-2,2′-p-(phenylene)-5,5′-bibenzimidazole] | 0.1 |
| F-pPBI [poly-2,2′-p-(perfluorophenylene)-5,5′-bibenzimidazole] | 0.065 |

### Production and Cell Measurement of a Catalyst-Coated Gas Diffusion Electrode (GDE):

The catalyst-coated gas diffusion electrode (GDE) is produced by screen printing on the anode side and the cathode side. The catalyst inks comprising polymer powder are used only for cathode GDEs. The thicknesses and loadings of anode and cathode GDEs are listed in Table 2.

TABLE 2

| | Anode | Cathode | Anode | Cathode |
|---|---|---|---|---|
| | thickness | thickness | loading | loading |
| Specimen | [μm] | [μm] | [mg_{Pt}/cm²] | [mg_{Pt}/cm²] |
| Comparative | 79 | 87 | 1.11 | 1.13 |
| specimen | | | | |
| GDE (pPBI) | 78 | 95 | 0.87 | 0.98 |
| GDE (F-pPBI) | 70 | 73 | 1.05 | 0.95 |

For the cell tests, the MEA (membrane-electrode assembly) composed of prefabricated GDEs and Celtec®-P membrane (from BASF Fuel Cell GmbH) (polymer electrolyte membrane based on polybenzimidazole, produced directly from phosphoric acid by a sol-gel process) is pressed together with a spacer to 75% of the starting thickness at 140° C. for 30 seconds. The active surface area of the MEA is 45 cm². The specimens are subsequently installed in the cell block and then tested at 160° C. with H₂ (anode stoichiometry 1.2) and air (cathode stoichiometry 2). The performance of the specimens at 1 A/cm² is compared in Table 3.

TABLE 3
Performance of the specimens at 1 A/cm²

| | Proportion | Resistance | Power density |
|---|---|---|---|
| | of polymer in | mΩcm² @ | [mW/cm² mg_{Pt}] @ |
| Specimens | the cathode | 1 A/cm² | 1 A/cm2 |
| Comparative specimen | 0 | 86 | 156 |
| Specimen with (pPBI) | 0.1 | 72 | 191 |
| Specimen with (F-pPBI) | 0.065 | 84.6 | 186 |

1-13. (canceled)

14. An ink, comprising:
(a) a catalyst material;
(b) a liquid medium; and
(c) polymer particles comprising at least one proton-conducting polymer selected from the group consisting of poly-2,2′-p-(phenylene)-5,5′-dibenzimidazole and poly-2,2′-p-(perfluorophenylene)-5,5′-dibenzimidazole,
wherein the at least one proton-conducting polymer is doped with acid.

15. The ink of claim 14, wherein the catalyst material comprises a noble metal.

16. The ink of claim 14, wherein the liquid medium is an aqueous medium.

17. The ink of claim 14, wherein the at least one proton-conducting polymer is doped with phosphoric acid.

18. The ink of claim 14, wherein the polymer particles have an average particle size of ≦100 μm, determined by laser light scattering.

19. The ink of claim 14, wherein a content of the proton-conducting polymer in the catalyst ink is from 1 to 30% by weight based on a total weight of the catalyst material.

20. The ink of claim 14, further comprising:
a perfluorinated polymer.

21. The ink of claim 20, wherein a content of the perfluorinated polymer in the catalyst ink is from 0.1 to 4% by weight based on a total weight of the proton-conducting polymer.

22. The ink of claim 14, further comprising:
a surfactant.

23. A process for producing the ink of claim 14, the process comprising:
mixing the catalyst material, the liquid medium, and the polymer particles.

24. A membrane-electrode assembly, comprising:
at least two electrochemically active electrodes which are separated by a polymer electrolyte membrane,
wherein the electrodes are obtained by a process comprising contacting the ink of claim 14 to the polymer electrolyte membrane.

25. A fuel cell, comprising:
a membrane-electrode assembly of claim 24.

26. The ink of claim 15, wherein the catalyst material further comprises at least one base metal selected from the group consisting of chromium, zirconium, nickel, cobalt, titanium, tungsten, molybdenum, vanadium, iron, and copper.

27. The ink of claim 15, wherein the catalyst material further comprises an oxide of a noble metal.

28. The ink of claim 15, wherein the catalyst material further comprises an oxide of at least one metal selected from the group consisting of chromium, zirconium, nickel, cobalt, titanium, tungsten, molybdenum, vanadium, iron, and copper.

29. The ink of claim 15, wherein the catalyst material is supported.

30. The ink of claim 15, wherein the catalyst material is support-free.

31. The process of claim 23, wherein the mixing further comprises a perfluorinated polymer.

32. The process of claim 23, wherein the mixing further comprises a surfactant.

33. The process of claim 31, wherein the mixing further comprises a surfactant.
